(19) United States
(12) Patent Application Publication
(10) Pub. No.: US 2023/0175240 A1
(43) Pub. Date: Jun. 8, 2023

(54) EXTENSION ROD INSTALLATION STRUCTURE HAVING SHOWER HEAD HOLDER

(71) Applicant: Xiamen Galenpoo Kitchen & Bathroom Technology Co, Ltd., Xiamen (CN)

(72) Inventor: Xiaoling Yan, Xiamen (CN)

(21) Appl. No.: 17/540,253

(22) Filed: Dec. 2, 2021

(51) Int. Cl. E03C 1/04; B05B 15/628

(52) U.S. Cl. CPC E03C 1/0408; B05B 15/628

(57) ABSTRACT

An extension rod installation structure having a shower head holder is disclosed. The extension rod installation structure includes a water outlet joint, a pipe joint, and an extension rod. The water outlet joint has an inlet end, a first outlet end connected to a hand-held shower head, and a second outlet end. The pipe joint has an inlet connecting end, an outlet connecting connected to an overhead shower head, and an installation connecting end. The second outlet end is hermetically connected to the inlet connecting end of the pipe joint. The extension rod is provided with a shower head holder. A top end of the extension rod is rotatably, hermetically connected to the installation connecting end of the pipe joint.

### BACKGROUND OF THE INVENTION

### 1. Field of the Invention

The present invention relates to a shower, and more particularly to an extension rod installation structure having a shower head holder.

### 2. Description of the Prior Art

Overhead shower heads and hand-held shower heads are common shower products in our daily life. In general, an overhead shower head and a hand-held shower head are installed in a bathroom to introduce water for taking a bath. In order to facilitate the placement of the hand-held shower head when not in use, a shower head holder is installed on the wall for the hand-held shower head to be held on the shower head holder. However, because the installation position of the shower head holder is immovable, it is difficult to adjust the height of the shower head for use when the shower head is placed on the shower head holder. It is inconvenient to use.

### SUMMARY OF THE INVENTION

The primary object of the present invention is to provide an extension rod installation structure having a shower head holder, which has a simple structure and is convenient in use.

In order to achieve the above object, the present invention adopts the following technical solutions.

An extension rod installation structure comprises a water outlet joint, a pipe joint, and an extension rod. The water outlet joint has an inlet end, a first outlet end that is hermetically connected to a hand-held shower head through a pipe, and a second outlet end. The pipe joint has an inlet connecting end, an outlet connecting end that is hermetically connected to an overhead shower head, and an installation connecting end. The second outlet end is hermetically connected to the inlet connecting end of the pipe joint. The extension rod is provided with a shower head holder for holding the hand-held shower head. A top end of the extension rod is rotatably, hermetically connected to the installation connecting end of the pipe joint.

Preferably, the extension rod is a telescopic rod.

Preferably, the extension rod includes an outer rod, an inner rod, and an outer jacket. The inner rod is inserted in the outer rod. One end of the outer rod, adjacent to the inner rod, is formed with a slit arranged axially. The outer jacket is screwed to an outer wall of the outer rod. When the outer jacket is unscrewed, the inner rod is movable in the outer rod. When the outer jacket is tightened, two sides of the slit are pushed to be close to each other, and the outer rod tightly embraces the inner rod so that the inner rod is immobile.

Preferably, the shower head holder is locked on the extension rod.

Alternatively, the shower head holder is in the form of a slide sleeve. The slide sleeve is selectively, movably clamped on the extension rod.

Preferably, the extension rod installation structure further comprises a hollow rod. A first second end of the hollow rod is rotatably, hermetically connected to the outlet connecting end of the pipe j oint. A second end of the hollow rod is rotatably, hermetically connected to an overhead shower head joint. The overhead shower head joint is hermetically connected to the overhead shower head.

Preferably, a joint seat is provided on the top end of the extension rod. A first mounting seat is provided on the first end of the hollow rod. A second mounting seat is provided on the second end of the hollow rod. The joint seat is rotatably connected to the installation connecting end of the pipe joint through meshing of teeth. The first mounting seat is rotatably connected to the outlet connecting end of the pipe joint through meshing of teeth. The second mounting seat is rotatably connected to the overhead shower head joint through meshing of teeth.

Preferably, the extension rod installation structure further comprises a first screw, a second screw, a first handle, and a second handle. The first screw is hermetically inserted through the joint seat, the installation connecting end of the pipe joint, the outlet connecting end of the pipe joint and the first mounting seat in sequence. A distal end of the first screw is screwed to the first handle. The second screw is hermetically inserted through the overhead shower head joint and the second mounting seat in sequence. A distal end of the second screw is screwed to the second handle.

Preferably, the second outlet end is hermetically connected to the inlet connecting end of the pipe joint through a quick mounting structure.

Preferably, a sealing ring is provided between the second outlet end and the inlet connecting end of the pipe joint. The second outlet end is insertedly connected to the inlet connecting end of the pipe joint and is secured through a limiting protrusion and a concave portion.

With the foregoing technical solutions, in the present invention, through the structural design of the water outlet joint, the pipe joint and the extension rod, the top end of the extension rod is rotatably, hermetically connected to the installation connecting end of the pipe joint. The extension rod is provided with the shower head holder for holding the hand-held shower head. When the top end of the extension rod is rotated around the installation connecting end of the pipe joint, the height of the shower head holder is adjustable, so as to change the height of the hand-held shower head on the shower head holder. When in use, the height of the hand-held shower head is adjustable. The use of the present invention is more convenient, and the overall structure of the present invention is simple.

### BRIEF DESCRIPTION OF THE DRAWINGS

FIG. 1 is a perspective view of a first embodiment of the present invention in a use state;

FIG. 2 is a first exploded view of the first embodiment of the present invention;

FIG. 3 is a second exploded view of the first embodiment of the present invention;

FIG. 4 is a perspective view of a second embodiment of the present invention when in use; and

FIG. 5 is a partial exploded view of a third embodiment of the present invention.

### DETAILED DESCRIPTION OF THE PREFERRED EMBODIMENTS

Embodiments of the present invention will now be described, by way of example only, with reference to the accompanying drawings.

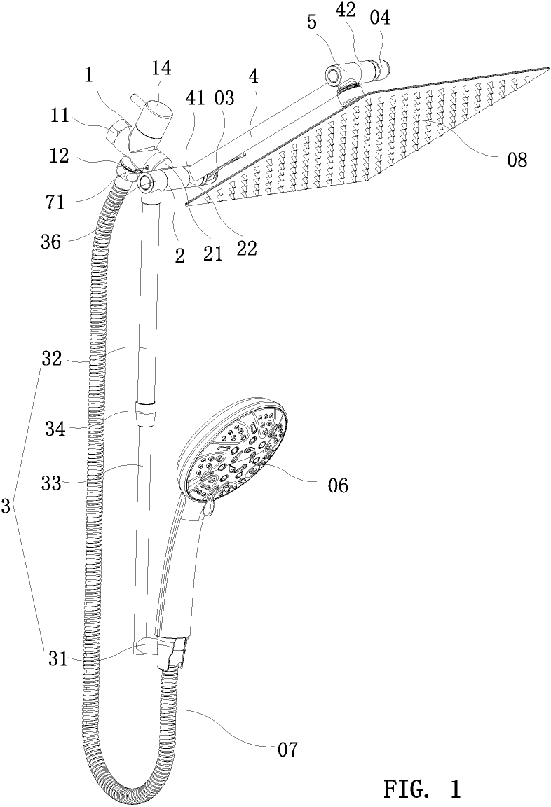

As shown in FIG. 1 through FIG. 5, the present invention discloses an extension rod installation structure having a shower head holder, comprising a water outlet joint 1, a pipe joint 2 and an extension rod 3. The water outlet joint 1 has an inlet end 11, a first outlet end 12 and a second outlet end 13. The pipe joint 2 has an inlet connecting end 21, an outlet connecting end 22, and an installation connecting end 23. The second outlet end 13 is hermetically connected to the inlet connecting end 21 of the pipe joint 2. The extension rod 3 is provided with a shower head holder 31 for holding a hand-held shower head 06. The top end of the extension rod 3 is rotatably, hermetically connected to the installation connecting end 23 of the pipe joint 2. The water outlet joint 1 is provided with a control handle 14. The control handle 14 is configured to control the inlet end 11 to communicate with the first outlet end 12 and/or the second outlet end 13.

Referring to FIG. 1, when in use, the first outlet end 12 is hermetically connected to the hand-held shower head 06 through a pipe 07. The outlet connecting end 22 is hermetically connected to an overhead shower head 08.

Therefore, in the present invention, through the structural design of the water outlet joint 1, the pipe joint 2 and the extension rod 3, the top end of the extension rod 3 is rotatably, hermetically connected to the installation connecting end 23 of the pipe joint 2. The extension rod 3 is provided with the shower head holder 31 for holding the hand-held shower head 06. When the top end of the extension rod 3 is rotated around the installation connecting end 23 of the pipe joint 2, the height of the shower head holder 31 is adjustable, so as to change the height of the hand-held shower head 06 on the shower head holder 31. When in use, the height of the hand-held shower head 06 is adjustable. The use of the present invention is more convenient, and the overall structure of the present invention is simple.

Furthermore, the present invention further comprises a hollow rod 4. A first second end of the hollow rod 4 is rotatably, hermetically connected to the outlet connecting end 22 of the pipe joint 2. A second end of the hollow rod 4 is rotatably, hermetically connected to an overhead shower head joint 05. The overhead shower head joint 5 is hermetically connected to the overhead shower head 08, so that it is convenient to adjust the angle and height of the overhead shower head 08 when in use for the overhead shower head 08 to spray water out.

Furthermore, in order to facilitate the forming and rotation of the extension rod 3 and the hollow rod 4 of the present invention, a joint seat 36 is provided on the top end of the extension rod 3, a first mounting seat 41 is provided on the first end of the hollow rod 4, and a second mounting seat 42 is provided on the second end of the hollow rod 4. The joint seat 36 is rotatably connected to the installation connecting end 23 of the pipe joint 2 through the meshing of teeth 6. The first mounting seat 41 is rotatably connected to the outlet connecting end 22 of the pipe joint 2 through the meshing of teeth 6. The second mounting seat 42 is rotatably connected to the overhead shower head joint 5 through the meshing of teeth 6.

Then, in order to facilitate the rotation of the extension rod 3 and the hollow rod 4, the present invention further comprises a first screw 01, a second screw 02, a first handle 03, and a second handle 04. The first screw 01 is hermetically inserted through the joint seat 36, the installation connecting end 23 of the pipe joint 2, the outlet connecting end 22 of the pipe joint 2, and the first mounting seat 41 in sequence. The distal end of the first screw 01 is screwed to the first handle 03. The second screw 02 is hermetically inserted through the overhead shower head joint 5 and the second mounting seat 42 in sequence. The distal end of the second screw 02 is screwed to the second handle 04. In an embodiment, the first screw 01 is hermetically inserted through the joint seat 36, the installation connecting end 23 of the pipe joint 2, the outlet connecting end 22 of the pipe joint 2, and the first mounting seat 41 by fitting a sealing ring 05. The second screw 02 is hermetically inserted through the top spray joint 5 and the second mounting seat 42 by fitting a sealing ring 05.

Furthermore, in order to facilitate the installation of the present invention, the second outlet end 13 is hermetically connected to the inlet connecting end 21 of the pipe joint 2 through a quick mounting structure 7.

In addition, a sealing ring 05 may be provided between the second outlet end 13 and the inlet connecting end 21 of the pipe joint 2. The second outlet end 13 is insertedly connected to the inlet connecting end 21 of the pipe joint 2, and is secured through a limiting protrusion 71 and a concave portion 72. In an embodiment, the concave portion 72 is disposed on the second outlet end 13, and the concave portion 72 includes two concave portions arranged symmetrically. The limiting protrusion 71 includes two limiting protrusions passing through the inlet connecting end 21 of the pipe joint 2 to be secured in the corresponding concave portions 72. The limiting protrusion 71 may be a screw. The limiting protrusion 71 is screwed through the inlet connecting end 21 of the pipe joint 2 and secured in the concave portion 72.

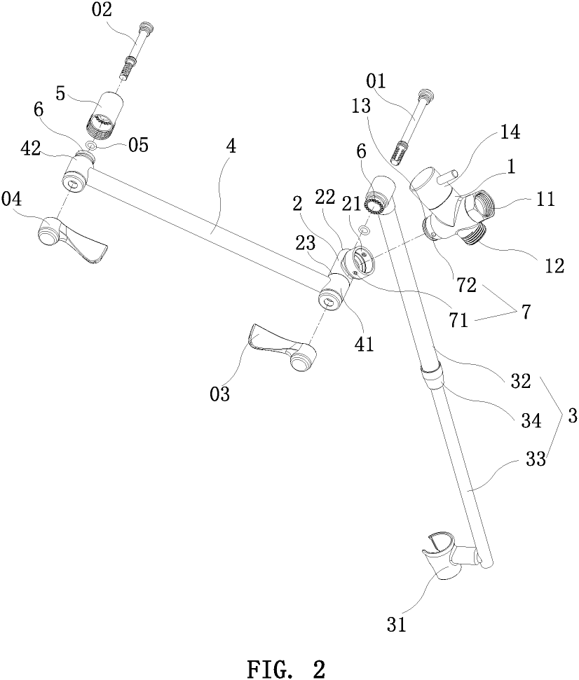

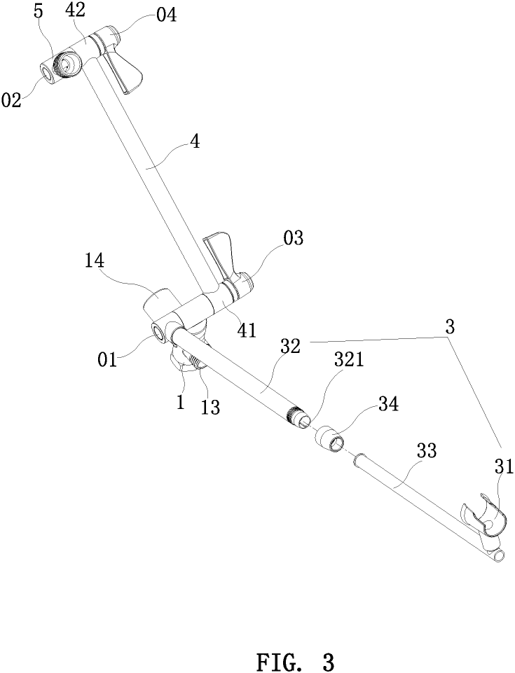

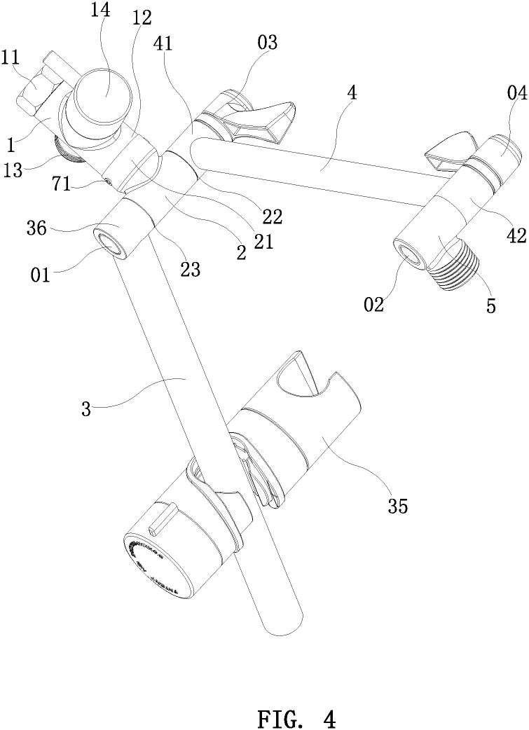

Please refer to FIG. 2, FIG. 3 and FIG. 4. The difference between the first embodiment and the second embodiment of the present invention is described below. In the first embodiment, the extension rod 3 is a telescopic rod. When the extension rod 3 is a telescopic rod, the extension rod 3 may include an outer rod 32, an inner rod 33 and an outer jacket 34. The inner rod 33 is inserted in the outer rod 32. The end of the outer rod 32, adjacent to the inner rod 33, is formed with a slit 321 arranged axially. The outer jacket 34 is screwed to the outer wall of the outer rod 32. When the outer jacket 34 is unscrewed, the inner rod 33 is movable in the outer rod 32. When the outer jacket 34 is tightened, two sides of the slit 321 are pushed to be close to each other, and the outer rod 32 tightly embraces the inner rod 33 so that the inner rod 33 is immobile. The shower head holder is in the form of a slide sleeve 35. The slide sleeve 35 is selectively, movably clamped on the extension rod 3. In the second embodiment, the shower head holder 31 is directly locked on the extension rod 3 through a fastener.

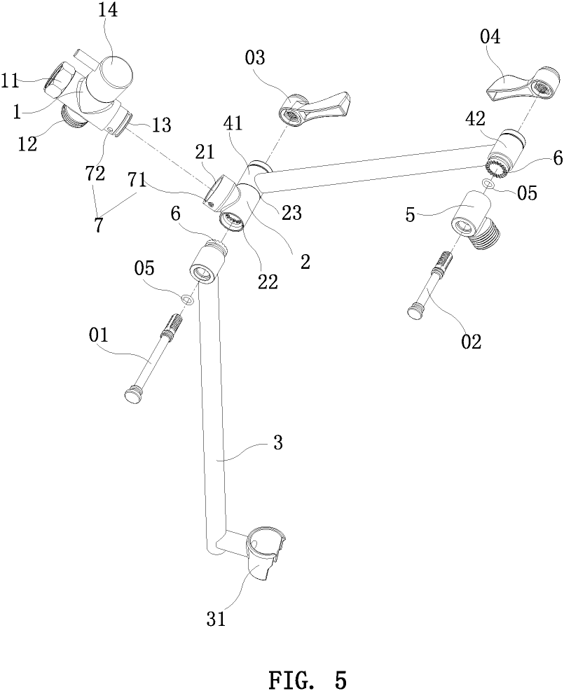

Please refer to FIG. 5, FIG. 2 and FIG. 3. The difference between the third embodiment and the first embodiment of the present invention is that the extension rod 3 is a straight rod.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An extension rod installation structure, comprising a water outlet joint, a pipe joint, and an extension rod; the water outlet joint having an inlet end, a first outlet end that is hermetically connected to a hand-held shower head through a pipe, and a second outlet end; the pipe joint having an inlet connecting end, an outlet connecting end that is hermetically connected to an overhead shower head, and an installation connecting end; the second outlet end being hermetically connected to the inlet connecting end of the pipe joint, the extension rod being provided with a shower head holder for holding the hand-held shower head, a top end of the extension rod being rotatably, hermetically connected to the installation connecting end of the pipe joint.

2. The extension rod installation structure as claimed in claim 1, wherein the extension rod is a telescopic rod.

3. The extension rod installation structure as claimed in claim 2, wherein the extension rod includes an outer rod, an inner rod and an outer jacket, the inner rod is inserted in the outer rod, one end of the outer rod, adj acent to the inner rod, is formed with a slit arranged axially, the outer jacket is screwed to an outer wall of the outer rod, when the outer jacket is unscrewed, the inner rod
is movable in the outer rod; when the outer jacket is tightened, two sides of the slit are pushed to be close to each other, and the outer rod tightly
embraces the inner rod so that the inner rod is immobile.

4. The extension rod installation structure as claimed in claim 1, wherein the shower head holder is locked on the extension rod.

5. The extension rod installation structure as claimed in claim 1, wherein the shower head holder is in the form of a slide sleeve, and the slide sleeve is selectively, movably clamped on the extension rod.

6. The extension rod installation structure as claimed in claim 1, further comprising a hollow rod, a first second end of the hollow rod being rotatably, hermetically connected to the outlet connecting end of the pipe joint, a second end of the hollow rod being rotatably, hermetically connected to an overhead shower head joint, the overhead shower head joint being hermetically connected to the overhead shower head.

7. The extension rod installation structure as claimed in claim 6, wherein a joint seat is provided on the top end of the extension rod, a first mounting seat is provided on the first end of the hollow rod, a second mounting seat is provided on the second end of the hollow rod, the joint seat is rotatably
connected to the installation connecting end of the pipe joint through meshing of teeth, the first mounting seat is rotatably connected to the outlet connecting end of the pipe joint through meshing of teeth, and the second mounting seat is rotatably connected to the overhead shower head joint through meshing of teeth.

8. The extension rod installation structure as claimed in claim 7, further comprising a first screw, a second screw, a first handle, and a second handle;
the first screw being hermetically inserted through the joint seat, the installation connecting end of the pipe j oint, the outlet connecting end of the pipe joint and the first mounting seat in sequence, a distal end of the first screw being screwed to the first handle; the second screw being hermetically inserted through the overhead shower head joint and the second mounting seat in sequence, a distal end of the second screw being screwed to the second handle.

9. The extension rod installation structure as claimed in claim 1, wherein the second outlet end is hermetically connected to the inlet connecting end of the pipe joint through a quick mounting structure.

10. The extension rod installation structure as claimed in claim 9, wherein a sealing ring is provided between the second outlet end and the inlet connecting end of the pipe joint, the second outlet end is insertedly connected to the inlet connecting end of the pipe joint and is secured through a limiting protrusion and a concave portion.
